(19) United States
(12) Patent Application Publication
(10) Pub. No.: US 2002/0195576 A1
(43) Pub. Date: Dec. 26, 2002

(54) Optical sensor device, signal processor therefor, and branching connector therefor

(76) Inventors: Yuichi Inoue, Kyoto (JP); Kouhei Tomita, Kyoto (JP); Hiroyuki Inoue, Osaka (JP)

Correspondence Address: BEYER WEAVER & THOMAS LLP, P.O. BOX 778, BERKELEY, CA, 94704-0778, US

(21) Appl. No.: 10/171,401

(22) Filed: Jun. 13, 2002

(30) Foreign Application Priority Data
Jun. 19, 2001 (JP) 2001-184597
Sep. 26, 2001 (JP) 2001-294447

(51) Int. Cl. G01V 8/00; G01N 21/86

(52) U.S. Cl. 250/559.29; 250/559.4

(57) ABSTRACT

A signal processor for an optical sensor device has a connector which is electrically connectable to both a displacement detector and a transmission detector but not at the same time. The displacement detector emits light and outputs a pair of detection signals based on the quantity of light reflected from a specified area and the transmission detector emits light and outputs a single detection signal based on the quantity of the emitted light transmitted through a specified area. The signal processor has a control unit which selectively carries out a measurement process or another measurement process, depending on which of the detectors is connected through the connector.

### BACKGROUND OF THE INVENTION

This invention relates to optical sensors for carrying out specified measurements by emitting light and receiving either the light which has traveled straight after being emitted and reached a specified position or the light which has been reflected by an object and come back. This invention also relates to a signal processor for carrying out a measurement from a light reception signal, as well as an optical sensor device using such a signal processor and a branching connector for such a signal processor.

There are different kinds of optical sensors of this type. Sensors for detecting the position, size or presence or absence of an object from the quantity of light which has passed through a specified detection area or the screened condition of the detection area may be referred to as a “transmitted light quantity measuring sensor”. Sensors for measuring the displacement, etc. of an object based on the position of arrival or the focal position of reflected light therefrom may be referred to as a “displacement measuring sensor”. Sensors for detecting the presence of an object from the quantity of light reflected therefrom may be referred to as a “reflected light quantity measuring sensor”. These sensors usually have a signal processor, separate from a detector having a light emitting element and a light receiving element, to process detection signals from the light receiving element.

FIG. 5 shows the structure of a typical displacement measuring sensor, characterized as having a detector (or a displacement detector 2a) integrating a light emitting part 3 and a light receiving part 4, electrically connected to a signal processor 1a by a cable. The light emitting part 3 of the displacement detector 2a includes a light projection lens 31, a laser diode 32 and its driver circuit 33. The light receiving part 4 includes a light receiving lens 41, a position sensitive device (PSD) 42, amplifier circuits 43 and 44 corresponding to a pair of light reception signals A and B, and an adder circuit 45 for adding signals A and B. Signals A and A+B are outputted to the signal processor 1a as the detection signals. The signal processor 1a includes not only sample-and-hold circuits 11 and 12 and A/D converter circuits 13 and 14 individually for these detection signals but also a CPU 15, a D/A converter circuit 16 and an output circuit 17.

The CPU 15 in the signal processor 1a transmits to the driver circuit 33 of the detector 2a a driver pulse signal P at specified time intervals for causing the laser diode 32 to emit light. After being reflected by the surface of a target object 5, this laser light is made incident through the light receiving lens 41 onto the PSD 42. Two light reception signals A and B with different intensities dependent on the positions of incidence are thereby outputted and added together by the adder circuit 45.

The pair of detection signals A and A+B outputted to the signal processor 1a is individually passed through the sample-and-hold circuits 11 and 12, converted into digital signals by the A/D converter circuits 13 and 14 and inputted to the CPU 15.

The CPU 15 calculates A/(A+B) from the digitalized signals A and A+B and obtains the distance to the target object by carrying out a linearity correction process. The result of this calculation is transmitted to the D/A converter circuit 16 to be converted into an analog signal and then outputted from the output circuit 17. The CPU 15 also compares the result of its calculation with a specified threshold value and outputs the result of this comparison as a binary data item.

FIG. 6 shows the structure of a transmitted light quantity measuring sensor, characterized as having a detector (referred to as a transmission detector 9) with its light emitting part 6 and light receiving part 7 not only separated but also disposed opposite each other with a specified distance in between and individually connected to a signal processor 8. The light emitting part 6 includes a light projection lens 61, a laser diode 62 and its driver circuit 63. The light receiving part 7 includes a light receiving lens 71, a photodiode 72 and an amplifier circuit 73. The signal processor 8 includes an sample-and-hold circuit 81, an AID converter circuit 82, a CPU 83, a D/A converter circuit 84 and an output circuit 85.

The CPU 83 in the signal processor 8 (like the CPU 15 described above) transmits a driver pulse signal to the driver circuit 63 of the light emitting part 6 to cause the laser diode 62 to emit light. The laser light emitted from the laser diode 62 is made into a parallel beam by the light projection lens 61 and travels straight to reach the light receiving part 7 if there is no object in between, being received by the photodiode 72. A light reception signal Q from the photodiode 72 is amplified by the amplifier circuit 73 and transmitted to the signal processor 8 as a detection signal. It is then passed through the sample-and-hold circuit 81 and the A/D converter circuit 82 and inputted to the CPU 83 as a digital signal.

The CPU 83 carries out processes such as detecting the extent to which the detection area is screened by an object (or the edge position of the object) or the screened width (or the size of the object) from the quantity of received light indicated by the received light reception signal. The CPU 83 outputs such a calculated value as an analog signal through the D/A converter circuit 84. It also compares the calculated value with a specified threshold value to determine the presence or absence of an object and outputs the result of such comparison as a binary data item.

Although not shown in FIGS. 5 and 6, these sensors also include a power source circuit inside the signal processor 1a or 8, serving to receive a current from an external source and to distribute it to various components of the device and to supply driving currents to the detecting part 2 and the light emitting and receiving parts 6 and 7.

As more and more functions are required to be performed by the signal processor, more complete display and input devices become necessary and the program for the CPU becomes complex. Although the signal processors of these sensors have a similar hardware structure, they are being designed and produced as a device dedicated to a particular kind of the sensor. As a result, the production cost of each signal processor becomes higher and it takes longer to design a new processor.

Moreover, the user is confronted with the problem of selecting appropriate sensors for different applications (to be determined depending upon what are objects to be detected, what physical quantity is to be detected under what environmental conditions and/or conditions of the sensor installation). Different kinds of sensors have been commercially available because there are different kinds of applications, and since each type of sensor incorporates a signal processor corresponding to the type of the sensor, the user has to be provided not only with different kinds of detector parts but also with different kinds of signal processor for different kinds of sensors.

### SUMMARY OF THE INVENTION

It is therefore an object of this invention to reduce the cost of producing signal processors and the labor of designing different kinds of signal processors for different sensors.

It is a more particular object of this invention to make the detectors of different kinds of sensors (such as displacement measuring sensors and transmission measuring sensors) connectable to signal processors of the same structure.

It is a further object of this invention to provide a signal processor for an optical sensor usable for different applications.

An optical sensor device embodying this invention may be characterized as comprising a displacement detector for emitting light and outputting a pair of reflection detection signals based on the quantity of this light reflected from a detection area specified therefor, a transmission detector for emitting light and outputting a transmission detection signal based on the quantity of transmitted light from a detection area specified therefor, and a signal processor for processing detection signals from these detectors. The signal processor comprises a connector which is electrically connectable to both of these detectors but not at the same time, a plurality of detection signal terminals on the connector for relaying signals from these detectors and a control unit receiving the detection signals from the detection signal terminals and selectively carrying out a first measurement process using the pair of detection signals from the displacement detector and a second measurement process by using the detection signal from the transmission detector.

The aforementioned detectors are each comprised of a light emitting part for emitting light and a light receiving part for receiving the portion of the emitted light which has been transmitted through or reflected from a specified detection area. The displacement detector uses a position detector element such as a PSD or a partitioned photodiode as its light receiving element adapted to output two light reception signals such that the position of the light is reflected on their ratio.

The displacement detector is preferably so structured that its light emitting and receiving parts are unistructurally incorporated and affixed within a single main body as shown in FIG. 5. The main body may be structured so as to be partitioned into two parts except for the portion where it is connected, with the light emitting part set inside one of them and the light receiving part set inside the other such that their positional relationship or the angle between their optical axes is made variable.

The transmission detector to be used according to this invention is for receiving the portion of emitted light which has traveled straight after being emitted without being screened off by any object and reached a specified light receiving position. Its light emitting and receiving parts may be separated as shown in FIG. 6 or may be connected such that the distance in between will be fixed.

Both of these detectors may be connected to the connector directly or indirectly, say, with a branching connector to be described below or a cable in between.

The light emitting part of each of these detectors includes a light emitting element such as a laser diode or an LED. The light receiving part of each of these detectors includes a light receiving element such as a PSD or a photodiode, as explained above. The signal processor may include a means for generating a driver signal for causing the light emitting part to emit light. Such a driver signal is a pulsed signal for causing the light emitting element to emit light at specified intervals. If such means is disposed within the signal processor, the driver signal is outputted through the connector to the detector.

Detection signals to be outputted from the detectors are obtained from a light reception signal from a light receiving element. They are electrical signals transmitted from the detectors through the connector to the signal processor and may indicate not only the presence or absence of an object but also its position, its size or the distance thereto.

The displacement detector is characterized as including a light receiving element adapted to output two light reception signals but the aforementioned pair of detection signals need not be one reception signal A and a sum A+B of this reception signal A and another reception signal B but may be these two reception signals A and B themselves.

The signal processor or the detectors may include signal pre-processing means such as sample-and-hold circuits for sampling detection signals in synchronism with the driver signals for light emission and A/D converter circuits for converting sampled analog light reception signals into digital signals. It is preferable to provide such a sample-and-hold circuit and an A/D converter circuit for each detection signal for being able to process pairs of detection signals from a displacement measuring type of detector. It is possible to place sample-and-hold circuits and A/D converter circuits in the detectors and to provide the signal processor only with an interface circuit for receiving digital data but it is preferable to incorporate these circuits in the signal processor from the point of view that it is desirable to make the detectors as small as possible.

The connector may be provided with separate detection terminals for receiving the pair of (reflection) detection signals from the displacement detector and the (transmission) detection signal from the transmission detector or these two types of detectors may be made to share common terminals.

The aforementioned control unit may preferably be formed with a CPU of a microcomputer programmed, for example, to selectively carry out either of the first and second processing in response to the switching operation by the user. Thus, it becomes possible to carry out the first processing by using the pair of reflection detection signals if it is a displacement detector that is connected to the connector and the second processing by using the single transmission detection signal if it is a transmission detector that is connected to the connector. With a control unit thus structured, detection signals from either kind of detector can be processed and the cost for producing the signal processor and the work for designing a signal processor for each detector can be reduced. It now goes without saying that such a control unit usable for either kind of applications is highly convenient to the user.

The present invention also relates to a signal processor characterized as comprising a connector having a plurality of detection signal terminals for relaying detection signals and a control unit for receiving the detection signals from these detection signal terminals and selectively carrying out a first measurement process by using a pair of these detection signals and a second measurement process by using one of these detection signals. A signal processor thus structured can carry out a specified first mode of signal processing by inputting detection signals through two of the specified terminals when a displacement detector is connected to the connector and a specified second mode of signal processing by inputting a detection signal through a specified one of the terminals when a transmitted light measuring detector is connected to the connector. These detection signal terminals, too, as described above, may be separately provided for receiving the pair of (reflection) detection signals from the displacement detector and the (transmission) detection signal from the transmission detector or these two types of detectors may be made to share common terminals.

According to a preferred embodiment, the connector is further provided with a terminal for relaying to the control unit the identification information indicative of the kind of detector connected thereto and the control unit is adapted to selectively carry out either the first or second measurement process, depending on the identification information received through the connector. This may be done, for example, by providing a memory storing such identification information to a detector and reading out this information at the time of the power-up. In this manner, the control unit automatically checks what kind of detector is being connected to the connector and carries out the appropriate measurement process corresponding to the kind of connected detector. If the control unit outputs a command signal (a read request signal) in order to obtain the identification information, the connector is further provided with a terminal for transmitting this command signal to the information-storing memory.

According to another preferable embodiment of the invention, the connector is further provided with a terminal for relaying the identification information to the control unit in response to the read request signal. After transmitting such a read request signal, the control unit will carry out the first measurement process if the identification information is returned from the connector and the second measurement process if the identification information is not returned. This mode of control is advantageous because there is no need to provide the transmitted light detector for detecting the quantity of transmitted light with a memory.

There is a reason for installing a memory storing identification information in the displacement detector and not in the transmission detector. It is because displacement detecting sensors are already provided with a memory device for storing data for correcting linearity between the sensor output and the real displacement and such a memory device can be easily utilized to additionally store the information on the identification of the detector.

In general, a displacement sensor uses a pair of detection signals and its signal processing is more complicated than for a transmitted light detecting sensor. Thus, transmission detectors are more likely to be provided with a CPU or a memory. No matter what the exact purpose is, if a detector includes a memory device, it is reasonable to use a part of such a memory to store the identification information. Transmitted light measuring sensors, on the other hand, are usually not provided with a memory because they are primarily used to determine whether or not the emitted light has been screened or not. Since the transmitted light may have a circular cross-sectional shape or there is a strong intensity distribution over the cross-sectional area, it is difficult to obtain a linearity relationship between the sensor output and the screened condition (the position or size of the screening object). Thus, a memory would have to be provided only for the purpose of storing identification information. If either a displacement detector or a transmission detector is to store identification information, it is desirable to choose the displacement detector to store its identification information in the memory which is likely to be already present.

The process of transmitting a read request signal and receiving identification information in return may be carried out only when power is switched on but it may be carried output constantly before a driver signal for emission of light is outputted. Thus, even if a detector is connected while the power source for the signal processor remains switched on, a measurement process appropriate for the kind of the connected detector can be started immediately.

The present invention further relates to a branching connector serving as means to be inserted for connecting between the connector of a signal processor as described above and the light emitting and receiving parts of a transmission detector. The connecting parts for making a connection to the light emitting and receiving parts and to the connector of the signal processor are herein respectively referred to as the first, second and third connecting part. These connections may be either direct or indirect through another intermediate connector or a cable. A branching connector of this kind serves to branch the signal route from the signal processor individually to the light emitting and receiving parts of the transmission detector.

According to a preferred embodiment of the invention, such a branching connector is provided with a pair of power line relaying terminals at each of the first, second and third connecting parts. Power lines in the signal processor are connected to the pair of power line relaying terminals at the third connecting part of the branching connector and then branched within the branching connector to the individual pairs of power line relaying connectors at the first and second connecting parts such that power can be transmitted to the light emitting and receiving parts of the transmission detector. According to another embodiment of the invention, two pairs of power line relaying terminals are provided at the third connecting part to receive power from the signal processor, each of the pairs of power line relaying terminals being connected individually to the pair of power line relaying terminals at the first or second connecting part. In either of these manners, power can be supplied to the transmission detector from a power source within the signal processor or from an external power source and through the signal processor such that there is no need to separately provide a power source to the transmission detector and hence that a prior art transmission detector as shown in FIG. 6 can be used for the purpose of this invention.

If two pairs of power line relaying terminals are provided to the third connecting part of the branching connector, the signal processor may also be provided with two pairs of relaying terminals. When a displacement detector is connected to such a signal processor, one of the pairs of the terminals remains disconnected.

The invention also relates to a signal processor of another kind characterized as comprising a connector having detection signal terminals for relaying detection signals from a connected detector, a mode inputting terminal (as mode inputting means) for receiving a command regarding a mode of signal processing to be carried out, and a control unit for selecting one of a plurality of preliminarily prepared modes of signal processing according to the command received through the mode inputting terminal and carrying out the selected mode of signal processing on the detection signal received through the connector. With a signal processor thus structured, different kinds of detectors can be connected because a plurality of measuring processes are preliminarily prepared. It is also possible to carry out different modes of processing by using a same detector. Thus, the cost for producing signal processors and the work required for designing different signal processors for different optical sensors can be reduced and a convenient signal processor for optical sensors capable of handling different kinds of applications can be used.

Detectors for measuring displacements and quantity of either transmitted or reflected light can be connected to a signal processor according to this invention. Detectors for quantity of reflected and transmitted light comprise similar components and are also similar in that only one detection signal representing the quantity of received light is used but they are different in that the light emitted from the light emitting part of the detector for quantity of reflected light is not directly received by its light receiving part and its light emitting and receiving parts are arranged such that when a target object to be detected is within a specified detection area the reflected light will be received by the light receiving part.

A signal processor according to this invention is characterized as having a plurality of measurement processes preliminarily prepared. This means that there are a plurality of processes which may be regarded as being different as calculation method. For example, the process of using a pair of detection signals from a displacement detector to obtain a distance value by calculations including subtraction is considered different from the process of using a single detection signal from a detector of quantity of light to make a judgment by means of a specified threshold value. On the other hand, a detector for quantity of transmitted light and a detector for quantity of reflected light may be regarded as carrying out the same process in that they both serve to make a judgment by using one detection signal and comparing it with a threshold value although they may use different threshold values. Similarly, two detectors using inverted logic between the received light and judgment output (such as whether the light receiving condition or the screened condition should be defined as the “ON” condition) are regarded as using the same process.

From the point of view of making the signal processor as compact as possible, it is preferable to provide only one connector with detection signal terminals. The signal processor can be made compact if a cable containing detection signal lines is extended from the casing of the signal processor with detection signal terminals provided at its tip. A plurality of connectors with detection signal terminals may be used for connecting a plurality of detectors at the same time.

A signal processor according to a preferred embodiment has a control unit adapted to carry out a first mode of processing by using a pair of displacement detection signals from a displacement detector and a second mode of processing by using a transmission detection signal from a transmitted light quantity detector. The aforementioned mode inputting terminal is preferably for relaying an identification signal from the connected detector to the control unit such that the control unit can select one of the signal processing modes depending on whether or not the received identification signal has been received through the mode inputting terminal or on the information carried by the identification signal and carries out the selected mode of signal processing. Such terminal for relaying identification information may be provided in the connector having a detection signal terminal. Alternatively, a same terminal may be used for receiving detection and identification signals such that they will be taken in at different timing.

According to an alternative embodiment, a manually operable switch (as mode inputting means) may be provided for selecting the mode of signal processing. This embodiment is advantageous in that the detector is not required to include its own identification information. According to still another embodiment, a signal input part may be provided for receiving a mode-switching signal from outside. In this embodiment, the mode-switching signal represents a command for selecting a processing mode and the detector is not required to include its own identification information.

It is not always the case that there is only one processing mode for each detector. For example, after a displacement detector is used to obtain a pair of detection signals, their sum may be compared with a specified threshold value to determine the quantity of received light. In such a case, a displacement measuring detector functions like a detector of quantity of reflected light. Depending on the application, the user may wish to render judgments based on displacement and/or quantity of light. With a control unit embodying this invention, either kind of judgment can be selectively rendered. With a manually operated switch and an externally generated mode-switching signal, highly automated applications can be handled by a single signal processor according to this invention.

### BRIEF DESCRIPTION OF THE DRAWINGS

FIG. 1 is an external diagonal view of an optical sensor device embodying this invention.

FIG. 2 is a schematic circuit diagram of the optical sensor device of FIG. 1.

FIG. 3 is a block diagram of a displacement measuring type of detector connected to a connector.

FIG. 4 is a block diagram of a transmitted light measuring type of detector connected to the connector.

FIG. 5 is a block diagram of a prior art displacement measuring type of optical sensor.

FIG. 6 is a block diagram of a prior art transmitted light measuring type of optical sensor.

### DETAILED DESCRIPTION OF THE INVENTION

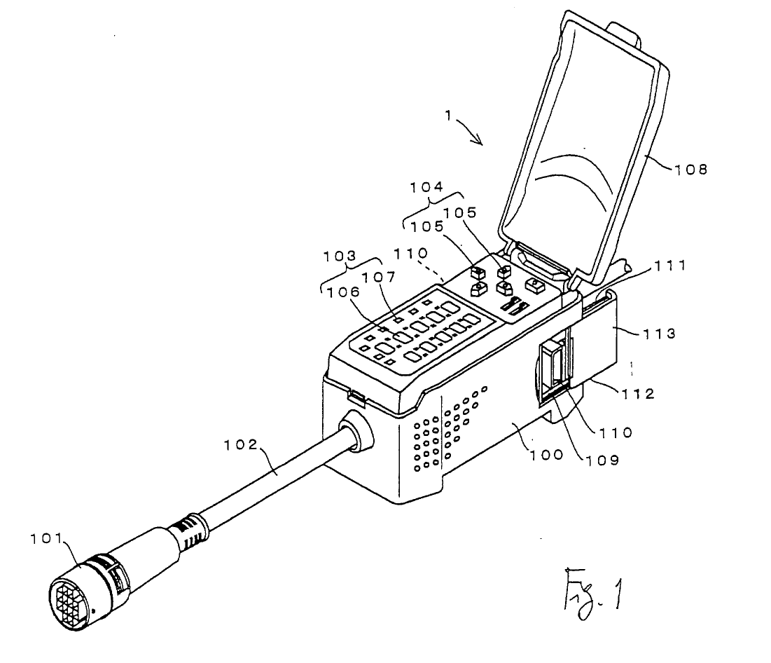

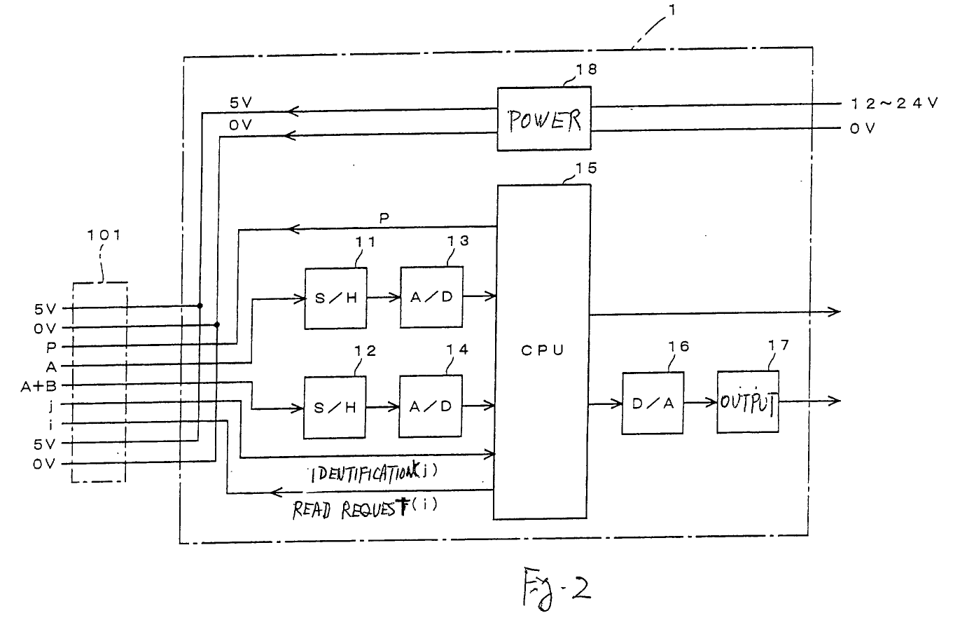

FIG. 1 is an external view of an example of signal processor 1 embodying this invention, having a main body 100 containing therein various circuits to be described below with reference to FIG. 2 and having a display part 103 and an input part 104 on its upper surface. A cord line 102 is extended from one end surface of the main body 100, and a connector 101 for electrically connecting to a detector is at the tip of this cord line 102.

The input part 104 includes a plurality of push buttons for variably setting numerical values and action modes. The display part 103 includes a plurality of digital displayers 106 for variably displaying alphanumeric symbols and warning lamps 107. A cover 108 is provided over the display part 103 and the input part 104.

On each side surface of the main body 100 is an opening 109 at which is disposed a connector 110 for signal transmission. When this signal processor is used for a displacement sensor, these connectors 110 are used for making connections to other signal processors for measuring the step height and/or thickness of a target object. Each opening 109 is provided with a door 113 slidable through guide grooves 111 and 112 for closing it when the connection is not necessary.

This signal processor 1 is designed not only to be connected to a displacement detector having integrated light emitting and receiving parts for detecting the displacement of a target object but also to be connected to a transmission detector having a light emitting part and a light receiving part separated from each other for detecting the presence of a target object.

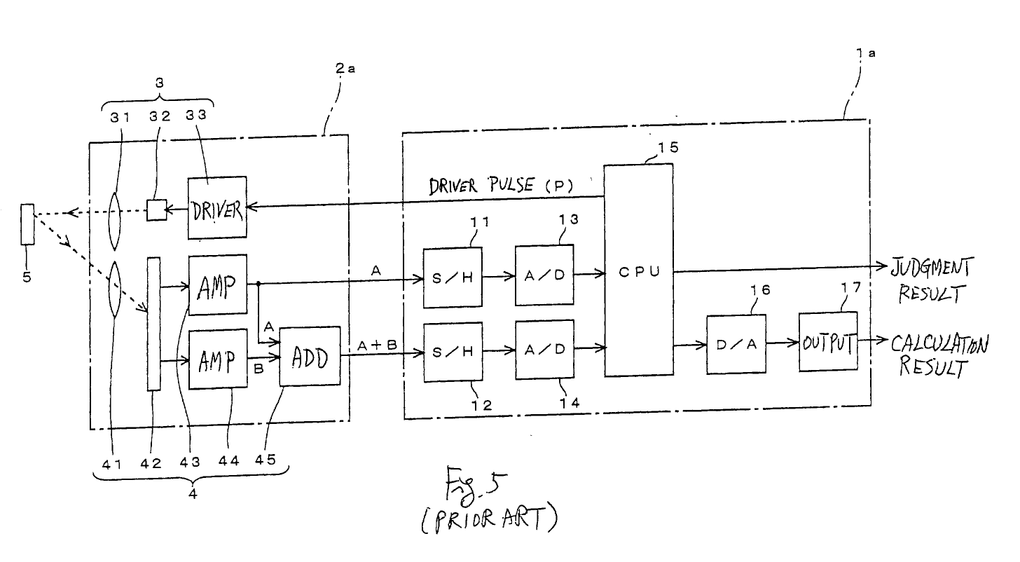

FIG. 2 shows the structure of circuits contained inside the main body 100 described above. Since this signal processor 1 is provided with circuits which are basically the same as those shown in FIG. 5, common components are indicated by the same symbols and may not be repetitiously explained. The circuits shown in FIG. 2, however, are to be understood as being all installed on a circuit board inside the main body 100. Although not shown in FIG. 2, furthermore, it is to be understood that the CPU 15 is also connected to the switches 105 of the input part 104, the displayers 106 and the lamps 107 of the display part 103 described above.

FIG. 2 is different from FIG. 5 in that there is included a power circuit 18 for receiving power from external DC sources of 12-24V and supply it to various components inside the main body 100. The power circuit 18 also serves to generate a voltage of 5V and supply it to the detectors.

The CPU 15 is adapted not only to generate driver pulse signals P for emission of light, as done by a prior art device, but also to input a pair of detection signals A and A+B through sample-and-hold circuits 11 and 12 and A/D converter circuits 13 and 14 so as generally to carry out the measurement of distance for the displacement sensor from these signals. The CPU 15 in this example is further adapted to output a read-request signal i to obtain an identification signal j (to be described below) and to switch its mode of operation if the identification signal is not received, using only the detection signal A+B to carry out a measurement. If read-request signals i are continuously outputted at regular intervals such that identification signals are constantly being retrieved, the user can quickly respond to connect a detector after power is put on or when the connection has been changed while measurements are being taken.

The connector 101 is provided not only with two power lines at voltages of 5V and 0V but also a signal line for transmitting the driver pulse signals P for emission of light, two signal lines for inputting the pair of detection signals A and A+B, a signal line for transmitting the aforementioned read-request signal i, and a terminal for relaying a signal line for inputting the identification signal j. This terminal for relaying the identification signal j may be referred to also as the “mode inputting terminal”.

When this signal processor 1 is connected to a transmission detector, power must be supplied separately to the light emitting and receiving parts. Thus, each of the power lines at 5V and 0V is branched inside the signal processor 1 and terminals are provided to the connector 101 individually for the branched lines.

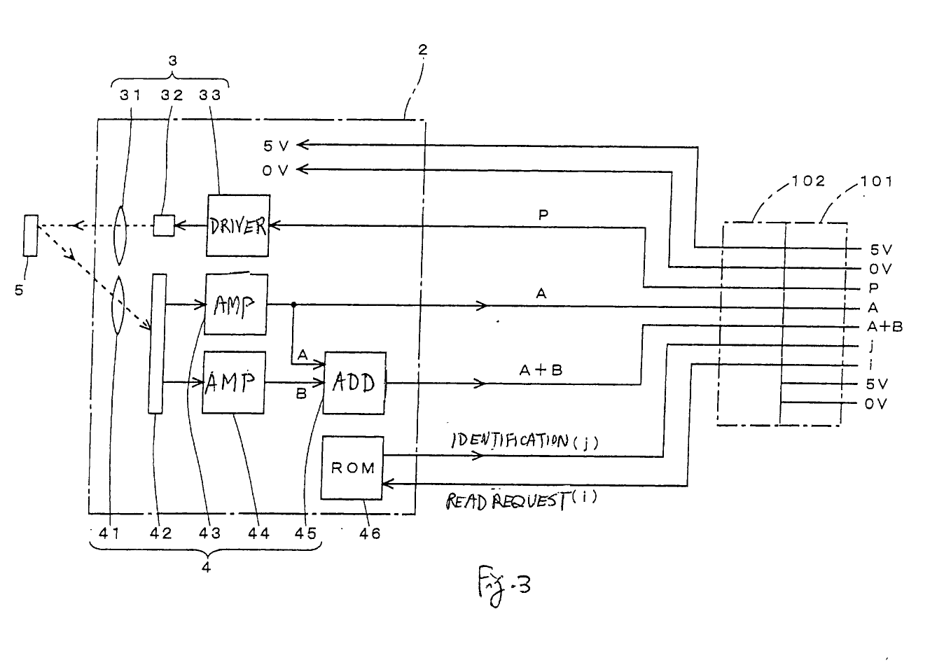

FIG. 3 shows more in detail the connector 101 shown in FIGS. 1 and 2 when it is connected to a displacement detector 2 which is structured similarly as shown in FIG. 5 but is provided also with a ROM 46 storing its identification information (for outputting the aforementioned identification signal j). This ROM 46 also stores in the form of a table data necessary for correcting linearity relationship between the real displacement (of a measured target object) and the sensor output. In other words, the signal processor 1 serves also to read out these correction data from the ROM 46 to carry out a linearity correction process. Thus, even if the displacement detector 2 is replaced with another displacement detector, the same high level of precision can be retained. In FIG. 3, too, corresponding components are indicated by the same symbols as in FIGS. 2 and 5 and may not be repetitiously explained.

This displacement detector 2 is connected to the aforementioned connector 101 through a relay connector 102 but, if necessary, a cable may be inserted between this relay connector 102 and the displacement detector 2. One of the two pairs of power lines and signal lines for driver pulse signal P, detection signals A and A+B, the read-request signal and the identification signal are relayed through the relay connector 102. With connections thus made, signals are exchanged between the light emitting and receiving parts 3 and 4 of the detector 2 and the CPU 15 of the signal processor 1 in conventional manners. The identification information in the ROM 46 is retrieved by a read-request signal i transmitted from the CPU 15 and the identification signal j is outputted to the CPU 15.

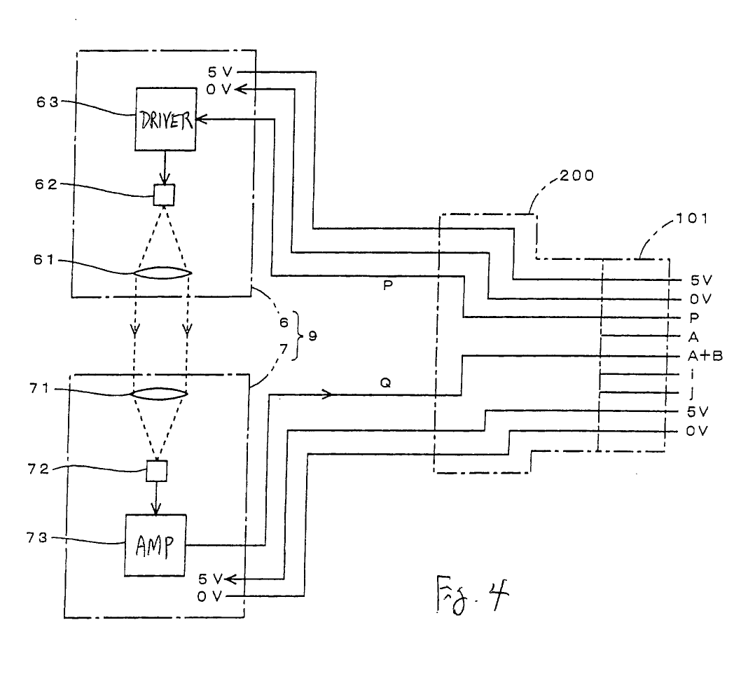

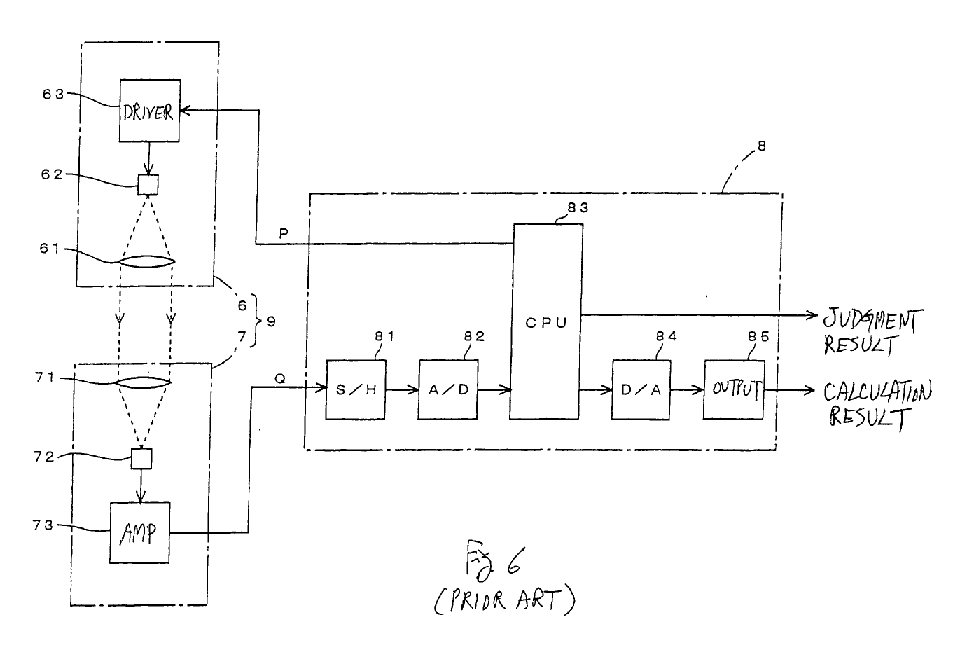

FIG. 4 shows the connector 101, as connected to a transmission detector 9 (as shown in FIG. 6 with corresponding components indicated by the same symbols). FIG. 4 shows the connector 101 connected to a branching connector 200 whereby signal lines are each branched into two lines individually connected (through intermediate connectors and cables which are not shown) to the light emitting and receiving parts 6 and 7. The pairs of power lines at 5V and 0V are separated by the branching connector 200 and individually led to the light emitting and receiving parts 6 and 7. A relay line for driver pulse signals P for the light emitting part 6 and another relay line for detection signal A+B for the light receiving part 7 are also formed through the branching connector 200. The branching connector 200 does not relay the detection signal A, the identification signal j or the read-request signal i.

With connections made as shown in FIG. 4, the driver pulse signals P are supplied to the light emitting part 6 through the connectors 101 and 200 to cause the laser diode 62 to emit light. If a detection signal Q is outputted in response from the photodiode 72 in the light receiving part 7, this detection signal Q is relayed through the terminals of the connectors 200 and 101 for signal A+B and inputted to the sample-and-hold circuit 12 of the signal processor 1.

Although an example was shown above wherein the power lines are branched inside the signal processor 1 and the branched power lines are led to the light emitting and receiving parts 6 and 7 through the connectors 101 and 200, the signal processor 1 may be designed to relay only one pair of power lines and the power lines may be branched inside the branching connector 200 to be individually led to the light emitting and receiving parts 6 and 7.

With a signal processor 1 thus structured, the CPU 15 outputs a read-request signal i at the time of power-up or reset to check the kind of the connected detector. If it is a displacement measuring kind of detector 2 that is connected to the connector 101, the corresponding identification signal j is read out from the ROM 46 and received by the CPU 15, and the CPU 15 is informed that a signal processing for a displacement measuring type of sensor is to be carried out, using detection signals A and A+B to measure the distance to the target object. The result of this measurement may be compared with a specified threshold value to determine whether or not the length or the height of the target object is “correct”.

If the connector 101 is connected to the light emitting and receiving parts 6 and 7 of a transmission detector 9 as shown in FIG. 4, no identification signal i is returned in response to the aforementioned read-request signal i and the CPU 15 is thereby informed that a signal processing for a transmitted light quantity detection is to be carried out, using only the detection signal A+B (or Q) to measure the degree of screening. The result of this measurement may also be compared to a specified threshold value for concluding whether or not an object has invaded the area between the light emitting and receiving parts 6 and 7.

Many variations and modification are possible within the scope of this invention over the disclosure given above. For example, when the light emitting and receiving parts 6 and 7 of a transmission detector 9 are connected to the connector 101, the detection signal Q may be received through the terminal for detection signal A (instead of that for A+B). When a detection sensor is connected, detection signals A and B may be directly inputted, allowing the CPU 15 to carry out the addition to obtain detection signal A+B.

Instead of relying on the presence or absence of the identification signal to determine what kind of measurement (signal processing) is to be carried out, a mode-switch may be provided to the input part 104 such that the mode selection may be made manually. In this manner, a conventional displacement measuring detector 2a as shown in FIG. 5 becomes also usable.

If the mode is made switchable while the displacement detector 2 shown in FIG. 3 is connected, the detection signal A+B may be used for detecting the light quantity and a displacement detector 2 can be used as a reflected light quantity detector. Instead of a manual switch, furthermore, a signal input part may be provided for receiving a mode-switching signal from outside.

In summary, according to this invention, when detection signals are received from a connected detector, one of a plurality of prepared processing modes is used for the processing. Thus, a single signal processor can be used in connection with different kinds of detectors.

What is claimed is:

1. An optical sensor device comprising:
a displacement detector for emitting light and outputting a pair of reflection detection signals based on the quantity of the emitted light reflected from a detection area specified therefor;
a transmission detector for emitting light and outputting a transmission detection signal based on the quantity of the emitted light transmitted through a detection area specified therefor; and
a signal processor for processing the reflection detection signals from said displacement detector and said transmission detectors, said signal processor including:
a connector which is electrically connectable to both said displacement detector and said transmission detector but not at the same time;
a plurality of detection signal terminals on said connector for relaying signals from said displacement detector and said transmission detector; and
a control unit for selectively carrying out a first measurement process by using said pair of reflected detection signals or a second measurement process by using said transmission detection signal.

2. A signal processor comprising:
a connector having a plurality of detection signal terminals for relaying detection signals; and
a control unit for receiving detection signals from said detection signal terminals and selectively carrying out a first measurement process using two of said detection signals received from two of said detection signal terminals or a second measurement process by using one of said detection signals received from one of said detection signal terminals.

3. A signal processor comprising:
a connector which is electrically connectable to both a displacement detector and a transmission detector but not at the same time, said displacement detector emitting light and outputting a pair of reflection detection signals based on the quantity of the emitted light reflected from a detection area specified therefor, said transmission detector emitting light and outputting a transmission detection signal based on the quantity of the emitted light transmitted through a detection area specified therefor;
a plurality of detection signal terminals on said connector for relaying said pair of reflection detection signals from said displacement detector and said transmission detection signal from said transmission detector; and
a control unit for selectively carrying out a first measurement process by using said pair of reflected detection signals or a second measurement process by using said transmission detection signal.

4. The signal processor of claim 3 wherein said connector further includes an identification information relaying terminal for relaying identification information to said control unit, said identification information indicating the kind of detector connected to said connector, and wherein said control unit selectively carries out said first measurement process or said second measurement process according to said identification information relayed from said identification information relaying terminal.

5. The signal processor of claim 3 wherein said connector is connectable to a displacement detector having a memory storing identification information for said displacement detector, said connector including a request outputting terminal for outputting a read request signal to said memory and an identification transmitting terminal for transmitting said identification information received from said memory to said control unit, and wherein said control unit serves to output said read request signal and to selectively carry out said first measurement process if said identification information is received thereafter or said second measurement process if said identification information is not received.

6. A branching connector for a signal processor, said signal processor comprising:
a connector which is electrically connectable to both a displacement detector and a transmission detector but not at the same time, said displacement detector emitting light and outputting a pair of reflection detection signals based on the quantity of the emitted light reflected from a detection area specified therefor, said transmission detector emitting light from a light emitting part and outputting from a light receiving part a transmission detection signal based on the quantity of the emitted light transmitted through a detection area specified therefor;
a plurality of detection signal terminals on said connector for relaying said pair of reflection detection signals from said displacement detector and said transmission detection signal from said transmission detector; and
a control unit for selectively carrying out a first measurement process by using said pair of reflected detection signals or a second measurement process by using said transmission detection signal;
said branching connector being connected between said connector and said transmission detector and comprising a first connecting part for connecting to said light emitting part, a second connecting part for connecting to said light receiving part and a third connecting part for connecting to said connector.

7. The branching connector of claim 6 wherein each of said first connecting part, said second connecting part and said third connecting part has a pair of power line relaying terminals and power lines in said signal processor are electrically connected to the pair of power line relaying terminals of said third connecting part and are branched to the pairs of power line relaying terminals at said first and second connecting parts.

8. The branching connector of claim 6 wherein each of said first connecting part and said second connecting part has a pair of power line relaying terminals and said third connecting part has two pairs of power line relaying terminals, power lines in said signal processor are electrically connected to the pairs of power line relaying terminals of said third connecting part and are connected therethrough individually to the pairs of power line relaying terminals at said first and second connecting parts.

9. A signal processor comprising:
a connector having detection signal terminals for relaying detection signals from a connected detector;
mode inputting means for receiving a command regarding a mode of signal processing to be carried out; and
a control unit for selecting one of a plurality of preliminarily prepared modes of signal processing according to said command received through said mode inputting means and carrying out the selected mode of signal processing on said detection signal received through said connector.

10. The signal processor of claim 9 wherein said control unit selectively carries out a first mode of processing by using a pair of displacement detection signals from a displacement detector or a second mode of processing by using a transmission detection signal from a transmitted light quantity detector.

11. The signal processor of claim 9 wherein said mode inputting means relays an identification signal from said connected detector to said control unit and wherein said control unit selects one of said modes depending on whether or not said identification signal has been received through said mode inputting means and carries out the selected mode of signal processing.
